(19) United States
(12) Patent Application Publication
(10) Pub. No.: US 2025/0337059 A1
(43) Pub. Date: Oct. 30, 2025

(54) POUCH CELL, AND METHOD OF MAKING IMPROVED POUCH CELLS

(71) Applicant: GM GLOBAL TECHNOLOGY OPERATIONS LLC, Detroit, MI (US)

(72) Inventors: Seung-Woo CHU, Sterling Heights, MI (US); Young Nam KIM, Troy, MI (US); Mansu PARK, Rochester Hills, MI (US)

(21) Appl. No.: 18/645,083

(22) Filed: Apr. 24, 2024

(51) Int. Cl. H01M 50/124; H01M 50/105; H01M 50/119; H01M 50/121; H01M 50/122; H01M 50/178; H01M 50/191; H01M 50/193; H01M 50/195; H01M 50/534

(52) U.S. Cl. CPC H01M 50/124; H01M 50/105; H01M 50/119; H01M 50/121; H01M 50/122; H01M 50/178; H01M 50/191; H01M 50/193; H01M 50/195; H01M 50/534

(57) ABSTRACT

A pouch cell formed of wall plies, each wall ply having a metal foil outer layer, and a polymeric inner layer. An external cathode lead tab with a polymer sealing film containing electrically conductive filler on at least one face of the external lead tab is heat-sealed between the edges of two wall plies. A method of making a pouch cell includes disposing a metallic external cathode lead tab with a polymer sealing film strip containing electrically conductive filler, between the edges of pouch wall plies, each pouch wall ply having a metal foil outer layer, and a polymeric inner layer, and applying heat and pressure to the wall plies to heat seal the external cathode lead tab and provide electrical connectivity between the metal foil layer of the wall ply and the external cathode lead tab.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

This disclosure relates to pouch cells, and in particular to pouch cells with an improved connection between external lead tabs and the wall material.

Pouch cells generally comprise an anode, a cathode, and an electrolyte, enclosed in a pouch formed from portions of a multilayered wall material whose edge margins are heat-sealed together. These wall plies often comprise at least a metal foil outer layer which contains the cell contents, and an inner layer of a heat-sealable and electrolyte-resistant polymer such as modified polypropylene, which protects the outer layer from the electrolyte, and acts as a thermal adhesive layer for joining the wall plies to form the sealed pouch. External lead tabs electrically connected to anode and cathode, extend between opposed portions of the wall ply and are sealing secured to the edge margins of the portions of the wall plies.

Minute defects in the wall plies, and in particular in the inner layer of the wall plies can occasionally cause leakage. Due to the nature of the pouch-forming process, general manufacturing process tolerances and control, and repeated cell handling and usage, defects can form in the inner layer which exposes the metal foil outer layer to the electrolyte in the pouch, forming a circuit between the anode of the cell and the metal foil intermediate layer of multilayered wall material that erodes the metal foil. In particular, aluminum from which the multilayered wall material is often made, forms a lithiated alloy in the electrolyte-exposed area as the naturally formed Al₂O₃ is easily attacked by acid in the electrolyte. Over time, these undesired side reactions can ultimately damage the metal foil intermediate layer and eventually allow electrolyte to leak from the pouch cell.

### SUMMARY

Embodiments of this disclosure provide an improved pouch cell for a battery, and in particular to a pouch cell with an improved connection with external lead tabs. Generally, one embodiment of pouch cell according to this disclosure comprises a pouch made of a multilayered wall material. The multilayered wall material comprises a metal foil intermediate layer and a polymeric inner layer, which protects the metal foil intermediate layer, and heat seals portions of the wall material together to form a pouch for containing the contents of the cell. The metal foil intermediate layer may optionally have an outer insulating protective cover layer.

The pouch contains an anode, a cathode, and an electrolyte. An external anode lead tab and an external cathode lead tab are connected to the anode and cathode, respectively, and extend from the pouch between opposed portions of the wall material, and are sealingly engaged therebetween. The external cathode lead tab has a strip of a polymeric sealing film containing electrically conductive filler on at least once face. The external cathode lead tab is heat-sealed between the edge margins of opposed inner layers of two portions of wall material. The electrically conductive filler in the strip of sealing film forms part of the heat seal and provides electrical conductivity between the metal foil intermediate layer of the wall material and the cathode connected to the external cathode lead tab.

The electrical connection between the cathode and the metal foil intermediate layer of the wall material allows the formation of a protective layer on the metal foil intermediate layer comprising AlF₃ when metal foil is exposed the electrolyte in the cell and the cell is operating above 3.4V. The AlF₃ provides protection from the lithium alloy reaction that would otherwise occur should a failure of the inner layer allow the electrolyte to contact the aluminum intermediate layer.

Further, the formation of a circuit between anode electrode and aluminum intermediate layer of the pouch wall material means that the cell is discharging the energy from in a parasitic manner. The resistance in the circuit among the cathode, the aluminum intermediate layer, and the cathode, is sufficiently high that a battery management system (BMS) in the battery pack can identify the defective pouch by comparing the voltages of the cells, and can give an alert before the electrolyte leaks from the cell in the battery pack.

The polymer sealing films on the external lead tab can optionally comprise at least one of polypropylene and polyphthalamide, capable of being heat sealed with the inner layer of the wall plies, and optionally can be the same material as the inner layer of the wall plies. The metal foil of the pouch plies and of the metal of the external lead tab can be aluminum or an aluminum alloy, or other suitable electrically conductive, and optionally relatively light weight, metal.

The electrically conductive filler in the polymeric sealing film can be metallic, for example aluminum, nickel, stainless steel, or aluminized steel. The electrically conductive filler can be powder, granules, needle-shaped particles, and or spikey particles. Alternatively, the conductive filler in the polymeric sealing film can be non-metallic, for example, diamond, fullerenes, graphite, carbon black, carbon fibers and nanofibers, carbon nanotubes, and graphene. As a result of the electrically conductive filler, the electrical resistance between the exposed aluminum layer of the pouch film and in the middle of the external cathode lead tab, as measured with a multimeter, is between about 1 kohm and about 20 kohms.

In some embodiments there can be conductive filler in the inner layer of the wall material as well. The conductive filler in the inner layer of the wall material can be concentrated adjacent the intermediate layers of the wall plies. This location may reduce electrical interaction between the electrolyte in the cell and the intermediate layer.

According to a second embodiment of this disclosure, embodiments of methods of making a pouch cell are provided. According to one such embodiment a metallic external cathode lead tab with a polymer sealing film containing electrically conductive filler on at least one face of the external cathode lead tab is disposed between the edge margins of two portions of the wall material, each portion of wall material having a metal foil outer layer, and a polymeric inner layer; applying heat and pressure to the wall portions to heat seal the external cathode lead tab between the wall portion, compressing the sealing film and thereby increasing the concentration of electrically conductive filler between metal foil outer layer in the wall material and the external cathode lead tab.

The sealing film can be compressed between about 30% and about 40% of its original thickness, achieving a sufficient concentration to provide a conductive path between the cathode connected to the external cathode lead tab and the metal foil outer layers of the wall material.

In an alternative to the first embodiment, the filler material can be disposed in relatively higher melting point polymer bodies, that do not materially soften at the temperature and pressures used to heat seal the wall material around the external lead tabs. Upon heating and compressive pressure during heat sealing the film on the external cathode lead tab and the inner layer of the wall material soften and flow, while the relatively higher melting point polymer bodies remain substantially intact increasing the concentration of conductive material between the external cathode lead tab and the outer metal layer of the wall material.

In either alternative to the first embodiment, the polymeric inner layer of the wall material can optionally also include electrically conductive filler, which is optionally concentrated adjacent the outer metallic layer to reduce electrical interaction between the electrolyte in the cell and the intermediate metallic layer.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a plan view of a pouch cell constructed according to the principles of this disclosure;

FIG. 2 is an enlarged cross-sectional view of the pouch cell;

FIG. 3 is an enlarged plan view of an external lead tab;

FIG. 4 is a plan view of is a schematic diagram showing the metallic external lead tab disposed between the edge margins of two wall plies prior to heat sealing;

FIG. 5 is a schematic diagram showing the metallic external lead tab disposed between the edge margins of two wall plies after to heat sealing;

FIG. 6A is a schematic diagram showing the location of the electrically conductive filler disbursed in the sealing strip; and

FIG. 6B is a schematic diagram showing the location of the electrically conductive filler disbursed in the sealing strip and liner of pouch material after heat sealing and mixing of the materials;

FIG. 7A is a schematic diagram showing the location of the electrically conductive filler disposed in higher melting point carrier bodies;

FIG. 7B is a schematic diagram showing the location of the conductive fillier in the higher melting point carrier bodies after heat sealing and mixing of the lower melting point materials.

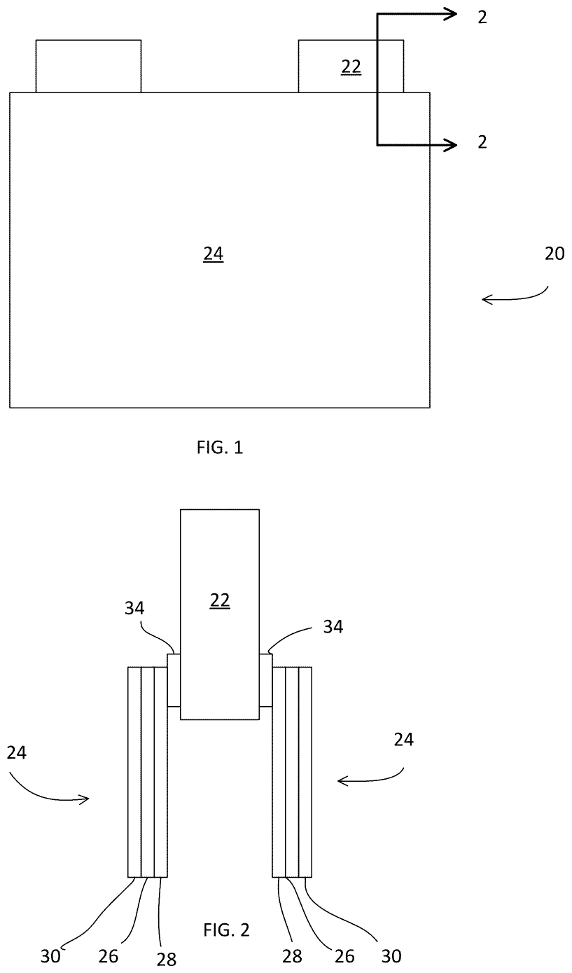

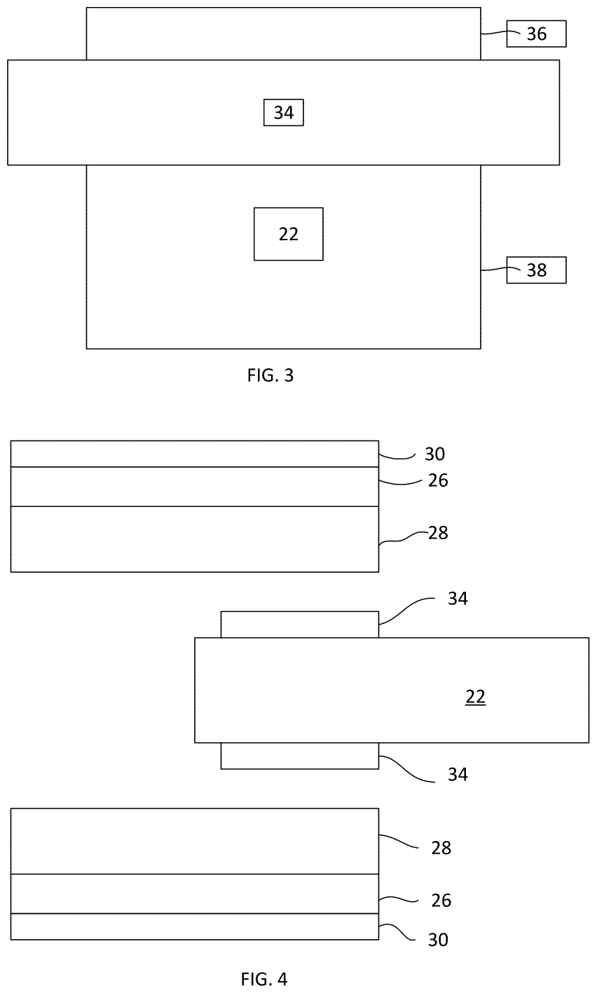

In the drawings, reference numbers may be reused to identify similar and/or identical elements.

### DETAILED DESCRIPTION

Embodiments of this disclosure provide an improved pouch cell 20 for a battery, and in particular to a pouch cell with an improved connection with an external cathode lead tab 22 that can in some instances reduce the chances of electrolyte leakage and/or make the potential for such leakage detectable before it actually occurs. Generally, one embodiment of pouch cell 20 according to this disclosure comprises pouch 24 made from one or more portions of a multilayer wall material. The multilayer wall material comprises a metal foil outer layer 26 and a polymeric inner layer 28. The metal foil outer layer may optionally have an insulating cover layer 30.

The metal foil outer layer 26 of the wall material can be aluminum or aluminum alloy, or some other metal foil that is relatively good conductor and, optionally, relatively light weight. The inner layer 28 can be made of polypropylene and/or polyphenylene sulfide or other suitable thermoplastic material that can be heat sealed and is resistant to the components of the battery chemistry, and particularly the electrolyte, usually a lithium salt dissolved in a solvent. The insulating cover 30 of outer layer 26 can be polyethylene terephthalate, or other suitable flexible, insulating polymer material.

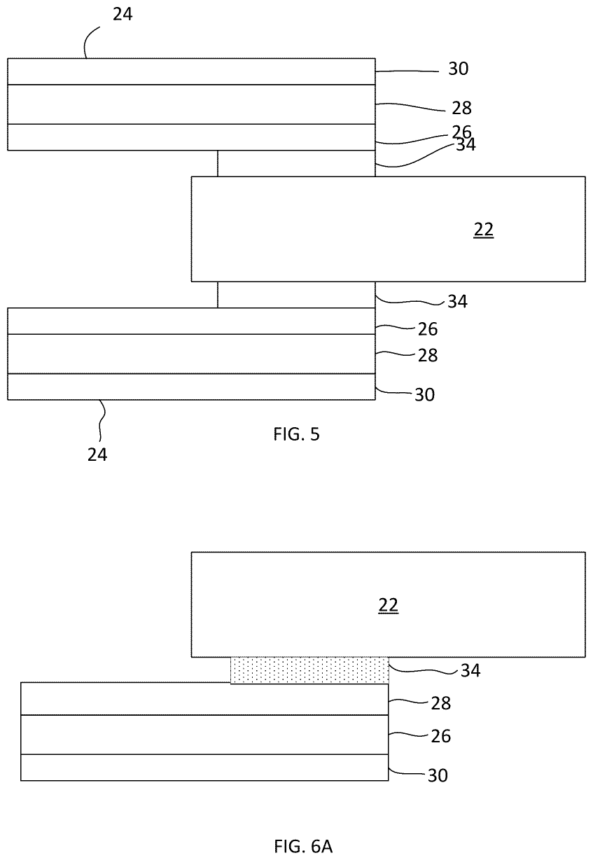

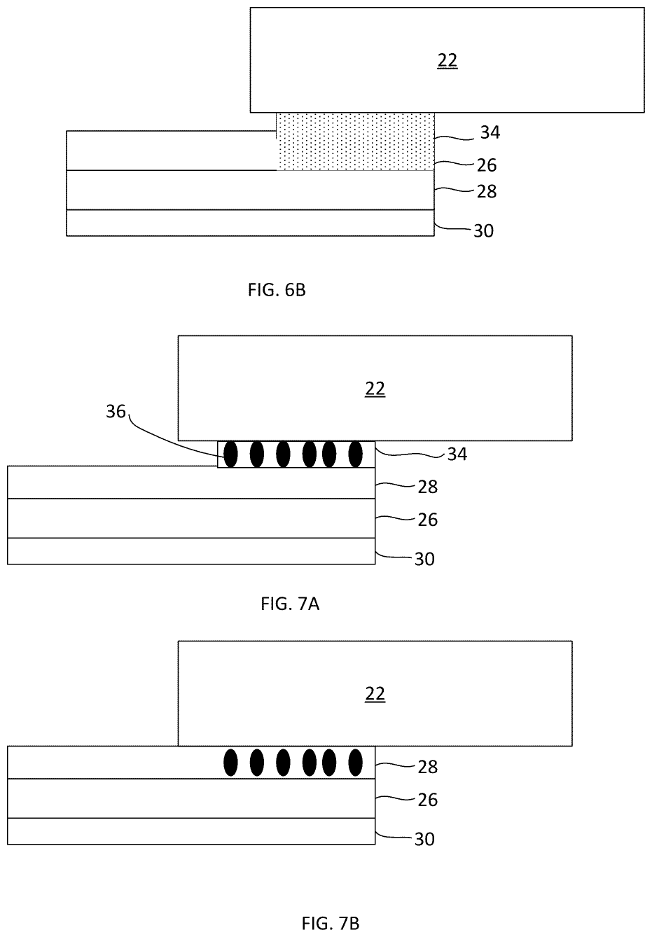

The cell includes an anode, a cathode, and electrolyte for facilitating ion exchange. There is an external anode lead tab and an external cathode lead tab for making an external electrical connection with the anode and the cathode of the cell. The external anode and cathode lead tabs extend between opposing portions of the wall material and are sealingly secured between the edge margins of the portions of the wall material. In accordance with the principles of this disclosure, the external cathode lead tab 22 has a strip 34 of a polymeric sealing film containing electrically conductive filler (indicated in FIGS. 6A, 6B and 7A, 7B).

Where the pouch is made of one piece of wall material, it can be sufficient to have just one strip 34, on one side of the external cathode lead tab 22, but where the pouch is made of two opposed pieces of wall material, there are desirably two strips 34, one on each side of the external cathode lead tab, for contacting each of the pieces of wall material.

The external cathode lead tab 22 is configured to be heat-sealed between the edge margins of opposed inner layers 28 of two portions of the wall material, with an inner tab portion 36 inside the pouch cell 20 and an outer tab portion 38 outside of the pouch cell. The electrically conductive filler in the strips 34 of sealing film provide electrical conductivity between the foil outer layers 26 of the wall material, and the external cathode lead tab 22, and thus the cathode connected thereto.

The external lead tabs, and in particular the external cathode lead tab 22, can be aluminum or aluminum alloy, or some other metal foil that is a relatively good conductor and, optionally, relatively light weight. The strips 34 of polymeric sealing film can be of polypropylene and/or polyphenylene sulfide, or other suitable thermoplastic material plastic that can be heat sealed to the inner layers 28 of the portions of the wall material and is resistant to the components of the battery chemistry, and particularly of the electrolyte.

The electrically conductive filler in the polymeric sealing film 34, can be metallic, for example aluminum, nickel, stainless steel, or aluminized steel, in the form of a powder, granules, needle-shaped particles, and/or spikey particles. Alternatively, the conductive filler in the polymeric sealing firm 34 can be non-metallic, for example, diamond, fullerenes, graphite, carbon black, carbon fibers and nanofibers, carbon nanotubes, and graphene. The electrically conductive filler is preferably at a higher concentration near the outer surface of the polymer sealing films (i.e., the exposed surface opposite from the lead tabs 22) prior to heat-sealing. The electrically conductive filler can be dispersed in the sealing film 34, so that when the wall material and the external lead tab are compressed and heat-sealed together, at least some of the electrically conductive filler disperses into the polymeric inner layers of the wall material, increasing the concentration of the electrically conductive filler material between the tab 22 and the outer layer 26 of the wall material.

As a result of the electrically conductive filler in the strips 34 of sealing film, the electrical resistance between the external cathode lead tab 22 and the outer layer 26 of the wall ply is between about 1 kohm and about 20 kohms. This creates an electrical connection or circuit between the cathode of the cell connected to the external cathode lead tab 22 and the outer foil layer 26 of the wall material. This connection or circuit can help form a protective layer comprising AlF₃ on the outer foil layer 26 in the event a defect of crack in the inner layer 28 exposes the outer foil layer to the electrolyte of the cell. The protective layer protects the naturally formed Al₂O₃ on the intermediate layer 28 from attack by the hydrofluoric acid in the electrolyte, preventing or at least delaying erosion of the intermediate layer and resulting electrolyte leakage from the pouch.

Instead, or in addition, the creation of a circuit between the anode and the outer foil layer 26 of the pouch wall material (as occurs where there is a defect or crack in the inner layer 28) means that the cell has a separate circuit which is discharging the energy from the battery cell in a parasitic manner, that a battery management system (BMS) in the battery pack can detect and use to identify this defective enclosure cell by comparing the voltages of the cells in the battery and generate a warning before electrolyte leaks from the cell into the battery pack.

Electrically connecting the outer aluminum layers of the wall material to the cathode can prevent or slow erosion of the metal foil outer layer should the inner layer of the wall material fail, and it can facilitate detecting when the inner layer fails. This can be accomplished with minimal change to the general design of the pouch cell or to general manufacturing process by including strip 34 of sealing film with electrically conductive filler.

In some alternative construction of the first embodiment of this disclosure, there can be conductive filler in the inner layers 28 of the wall plies 24 as well. This requires some change to the conventional design and manufacturing process, but can facilitate electrically connecting the metal foil outer wall and the cathode. The conductive filler in the inner layers of the wall plies 24 can be concentrated adjacent the intermediate layers 26 of the wall plies 24, to reduce electrical interaction between the electrolyte and the intermediate layers.

In another alternative construction of the first embodiment of this disclosure, the electrically conductive filler material can be disposed in relatively higher melting point polymer bodies 36 (FIGS. 7A, 7B), that do not materially soften at the temperature and pressures used to heat seal the wall material around the external cathode lead tab. Upon heating and compressive pressure during heat sealing the film 34 on the external cathode lead tab 22 and the inner layer 28 of the wall material soften and flow, while the relatively higher melting point polymer bodies 36 remain substantially intact increasing the concentration of conductive material between the external cathode lead tab 22 and the outer metal layer 26 of the wall material.

According to a second embodiment of this disclosure, embodiments of methods of making a pouch cell are provided. According to one such embodiment a metallic external cathode lead tab 22 with a strip 34 of polymer sealing film containing electrically conductive filler on each face of the external lead tab is disposed between the edge margins of two portions of wall material, each portion having a metal foil intermediate layer 26, and a polymeric inner layer 28. Heat and pressure are applied to the wall plies 24 to heat seal the external lead tab 22 to the wall plies, compressing the strips 34 of sealing film and thereby increasing the concentration (volume fraction) of the electrically conductive filler between each wall ply 24 and the external lead tab 22.

The strips 34 of sealing film can be compressed between about 30% and about 40% of their original thickness, achieving a sufficient concentration of the electrically conductive filler to provide a conductive path between the metallic external cathode lead tab 22 and the metallic foil outer layers 26 of the wall material. The electrically conductive filler can be disposed in higher melting point polymer bodies 36, such that heating and compression of the sealing film drives some of the electrically conductive filler into the polymeric inner layers 28 of the wall material.

The polymeric inner layer 28 of each wall ply 24 can optionally include electrically conductive filler, which can be disposed adjacent the foil intermediate layer 26. Thus, when the wall material and the metallic external lead tab 22 are heat sealed together, the electrically conductive filler in the polymeric layer 28 and in the strips 34 are concentrated, creating a conductive path between the external cathode tab and the metallic foil outer layer 26 through the seal formed between the ply walls and the metallic external lead tab.

In an exemplary embodiment, the outer layer 26 is aluminum 50 μm thick, the inner layer 28 is at least one of polypropylene, polyphthalamide, and polyphenylene sulfide 80 μm thick, and the insulating cover layer 30 is polyethylene terephthalate 24 80 μm thick. The external lead tabs, including the external cathode lead tab 22 is aluminum or an aluminum alloy 400 μm thick, and the strips 34 of polymer sealing film are each at least one of polypropylene, polyphthalamide, and be polyphenylene sulfide 150 μm thick. After compression and heat sealing the inner layers 28 and the strips 34 of polymer sealing film soften and flow, increasing the density or concentration of the conductive filler between the outer layer 26 and the external lead tab 22.

As a result of the electrically conductive filler in the sealing film 34, the electrical resistance between the external cathode lead tab 22 and the outer layers 26 of the wall material is between about 1 k ohm and about 20 kohms. This creates an electrical connection or circuit between the cathode of the cell connected to the external lead tab 22 and the intermediate foil layer 26 of the wall material. This connection or circuit can help form a protective layer comprising ALF₃ on the foil outer layer 26 in the event a defect or crack in the inner layer 28 exposes the intermediate foil layer to the electrolyte of the cell. The protective layer protects the naturally formed Al₂O₃ on the outer layer 28 from attack by the hydrofluoric acid in the electrolyte, preventing or at least delaying erosion of the outer layer and resulting electrolyte leakage from the pouch.

Instead, or in addition, the creation of a circuit between the anode and the intermediate foil layer 26 of the pouch film means that the cell has a separate circuit which is discharging the energy from the battery cell in a parasitic manner, that the battery management system (BMS) in the battery pack can detect and use to identify this defective enclosure cell by comparing the voltages of the cells in the battery and generate a warning before electrolyte leaks from the cell into the battery pack.

What is claimed is:

1. A pouch cell comprising an anode, a cathode, and an electrolyte disposed in a pouch formed of at least one wall ply having a metal foil outer layer and a polymeric inner layer; and metallic external anode and cathode lead tabs connected to the anode and cathode, respectively, each external lead tab having a portion extending out of pouch between opposed portions of the at least one wall ply and being sealingly secured with a heat seal between the edge margins of the opposed portions of the at least one wall ply, the heat seal securing the external cathode lead tab including a polymer sealing film on the external cathode lead tab containing electrically conductive filler sufficient to establish an electrical connection between the metal foil outer layer of the at least one wall ply and the cathode connected to the external cathode lead tab.

2. The pouch cell according to claim 1 wherein the polymer sealing film on the external cathode lead tab comprises at least one of polypropylene and polyphenylene sulfide.

3. The pouch cell according to claim 2 wherein the metal foil outer layer comprises aluminum or an aluminum alloy.

4. The pouch cell according to claim 3 wherein the metallic external lead tabs comprise aluminum or an aluminum alloy.

5. The pouch cell according to claim 1 wherein the electrically conductive filler in the sealing film on the external cathode lead tab is metallic.

6. The pouch cell according to claim 5 wherein the electrically conductive filler in the sealing film on the external cathode lead tab comprises at least one of aluminum, nickel, stainless steel, or aluminized steel.

7. The pouch cell according to claim 5 wherein the electrically conductive filler in the sealing film on the external cathode lead tab comprises is disposed in polymer bodies having a higher melting point than the sealing film.

8. The pouch cell according to claim 7 wherein the polymer bodies are sized sufficiently to provide electrical conductivity between the external cathode lead tab and the outer layer of the wall ply upon heat sealing.

9. The pouch cell according to claim 1 wherein the electrically conductive filler in the sealing film on the external cathode lead tab is non-metallic.

10. The pouch cell according to claim 9 wherein the electrically conductive filler comprises at least one of diamond, fullerenes, graphite, carbon black, carbon fibers, carbon nanofibers, carbon nanotubes, and graphene.

11. The pouch cell according to claim 9 wherein the electrically conductive filler in the sealing film on the external cathode lead tab comprises is disposed in polymer bodies having a higher melting point than the sealing film.

12. The pouch cell according to claim 11 wherein the polymer bodies are sized sufficiently to provide electrical conductivity between the external cathode lead tab and the outer layer of the wall ply upon heat sealing.

13. The pouch cell according to claim 9 wherein the electrical resistance between the second external lead tab and the metal foil outer layer of the at least one wall ply is between about 1 kohm and about 20 kohms.

14. The pouch cell according to claim 1 further comprising electrically conductive filler in the inner layers of the wall plies, which together with the electrically conductive filler in the sealing film, providing electrical conductivity between the foil layer of the at least one wall ply and the external cathode lead tab.

15. The pouch cell according to claim 14 wherein the conductive filler in the inner layers of the wall plies is concentrated adjacent the outer layers of the wall plies.

16. A method of making a pouch cell comprising: disposing a metallic external cathode lead tab with a polymer sealing film strip containing electrically conductive filler on at least one face of the external cathode lead tab, between the edge margins of two portions of pouch wall plies, each portion of pouch wall ply having a metal foil outer layer, and a polymeric inner layer; applying heat and pressure to the portions of wall plies to heat seal the external cathode lead tab to the portions of the wall ply, compressing the sealing film and thereby providing electrical connectivity between the outer metal foil layer of the wall ply and the cathode connected to the external cathode lead tab.

17. The method of making a pouch cell according to claim 16, wherein the sealing film strip is compressed by between about 30% and about 40% of its original thicknesses.

18. The method of making a pouch cell according to claim 17 wherein the polymeric inner layer of each wall ply includes electrically conductive filler, which together with the electrically conductive filler in the sealing film, providing electrical conductivity between the foil layer of the at least one wall ply and the external cathode lead tab.

19. The method of making a pouch cell according to claim 18 wherein the electrically conductive filler in the sealing film layer is concentrated adjacent the surface of the sealing film layer on the external cathode lead tab, such that compression of the sealing film layers drives some of the electrically conductive filler into the polymeric inner layer of the wall ply.
